(19) United States
(12) Patent Application Publication
(10) Pub. No.: US 2023/0415731 A1
(43) Pub. Date: Dec. 28, 2023

(54) VEHICLE CONTROL SYSTEM, VEHICLE CONTROL METHOD, AND STORAGE MEDIUM

(71) Applicant: TOYOTA JIDOSHA KABUSHIKI KAISHA, Toyota-shi Aichi-ken (JP)

(72) Inventors: Miki Nomoto, Nagoya-shi Aichi-ken (JP); Yuka Nishiyama, Toyota-shi Aichi-ken (JP); Kenichi Okumura, Gotemba-shi Shizuoka-ken (JP); Ryota Tomizawa, Mishima-shi Shizuoka-ken (JP); Tatsuya Sugano, Sunto-gun Shizuoka-ken (JP); Yushi Seki, Ashigarakami-gun Kanagawa-ken (JP); Tokuhiro Masui, Nagoya-shi Aichi-ken (JP)

(73) Assignee: TOYOTA JIDOSHA KABUSHIKI KAISHA, Toyota-shi Aichi-ken (JP)

(21) Appl. No.: 18/131,965

(22) Filed: Apr. 7, 2023

(30) Foreign Application Priority Data
Jun. 28, 2022 (JP) 2022-103753

(51) Int. Cl. B60W 30/09; B60W 50/14

(52) U.S. Cl. CPC B60W 30/09; B60W 50/14; B60W 60/0017

(57) ABSTRACT

A control system for a vehicle including a recognition sensor, an information processing device, and a notification device has the following features. The information processing device executes a process of determining whether a notification condition is satisfied based on information of a recognition result by the recognition sensor, map information of an endemic animal distribution area indicating an area in which a region-specific wild animal inhabits, and information of a vehicle's own position, a process of notifying at least an occupant of a warning or an alarm regarding the type of the region-specific wild animal via the notification device when it is determined that the notification condition is satisfied, and a process of executing danger avoidance driving of avoiding a crisis caused by the region-specific wild animal based on a predetermined condition when the detection information of the region-specific wild animal is included in the information of the recognition result.

### CROSS-REFERENCE TO RELATED APPLICATION

This application claims priority to Japanese Patent Application No. 2022-103753 filed on Jun. 28, 2022, incorporated herein by reference in its entirety.

### BACKGROUND

### 1. Technical Field

The present disclosure relates to a vehicle control system, a vehicle control method, and a storage medium, the vehicle control system including a recognition sensor, an information processing device, and a notification device.

### 2. Description of Related Art

Japanese Unexamined Patent Application Publication No. 2019-200690 (JP 2019-200690 A) discloses a technique for presenting a possibility of running out of a moving body hidden in a shadow. In this technique, a message is notified to an occupant via a display unit or a speaker provided in a vehicle. The message indicates an attention to the possibility that the moving body appears on a road.

### SUMMARY

By the way, a region-specific wild animal such as a wild boar and a bear lives in areas such as mountain roads and rural roads. There is a risk of encountering the region-specific wild animal when the vehicle travels in areas such as the mountain roads and the rural roads. When the related art is applied to such a case, no safety action is taken to avoid a danger from the region-specific wild animal. That is, in the related art, only notification of a message prompting attention regarding the appearance of the region-specific wild animal is performed. Therefore, in the related art, the safety of the occupant may not be able to be secured when the region-specific wild animal appears.

The present disclosure provides a technique capable of avoiding a danger from the region-specific wild animal when the region-specific wild animal appears.

A vehicle control system according to a first aspect includes: a recognition sensor; a notification device; and an information processing device that executes processes including determining whether a notification condition is satisfied based on information of a recognition result by the recognition sensor, map information of an endemic animal distribution area, and information of an own position of a vehicle, the endemic animal distribution area indicating an area in which a region-specific wild animal inhabits, notifying at least an occupant of a warning or an alert regarding a category of the region-specific wild animal via the notification device when the information processing device determines that the notification condition is satisfied, and executing danger avoidance driving for avoiding a danger caused by the region-specific wild animal based on a predetermined condition when the information of the recognition result includes detection information of the region-specific wild animal.

In a second aspect, in addition to the first aspect, the following feature is further included. The information processing device is configured to acquire the map information of the endemic animal distribution area from a management device that is able to communicate with the vehicle.

In a third aspect, in addition to the first aspect or the second aspect, the following features are further included. The notification condition includes at least one of conditions including a first condition in which a distance from the own position to the endemic animal distribution area is less than a threshold value, a second condition in which the own position is included in the endemic animal distribution area, and a third condition in which the information of the recognition result includes the detection information of the region-specific wild animal. The information processing device is configured to determine that the notification condition is satisfied when at least one of the first condition, the second condition, and the third condition is satisfied.

In a fourth aspect, in addition to the third aspect, the following feature is further included. The information processing device is configured to execute processes including: notifying at least the occupant of the alert regarding the category of the region-specific wild animal via the notification device when determination is made that the notification condition is satisfied by at least satisfying the third condition; and notifying at least the occupant of the warning regarding the category of the region-specific wild animal via the notification device when determination is made that the notification condition is satisfied without satisfying the third condition.

In a fifth aspect, in addition to the first aspect or the second aspect, the following features are further included. The information of the recognition result includes information of a distance from the vehicle to the region-specific wild animal and information of a danger level of the region-specific wild animal, and the predetermined condition includes at least one of a condition in which the distance is less than a threshold value and a condition in which the danger level is equal to or higher than a predetermined level. In a sixth aspect, in addition to the first aspect or the second aspect, the

following feature is further included. The danger avoidance driving includes at least one of operations including: at least one vehicle operation from among steering, acceleration, and deceleration of the vehicle; an operation for changing a travel route of the vehicle; an operation for locking a door of the vehicle; an operation for fully closing a window of the vehicle; and an operation for controlling suppression of a driving sound of the vehicle.

In a seventh aspect, a vehicle control method including a recognition sensor, an information processing device, and a notification device includes determining whether a notification condition is satisfied based on information of a recognition result by the recognition sensor, map information of an endemic animal distribution area, and information of an own position of the vehicle, the endemic animal distribution area indicating an area in which a region-specific wild animal inhabits; notifying at least an occupant of a warning or an alert regarding a category of the region-specific wild animal via the notification device when determination is made that the notification condition is satisfied; and executing danger avoidance driving for avoiding a danger caused by the region-specific wild animal based on a predetermined condition when the information of the recognition result includes detection information of the region-specific wild animal.

In an eighth aspect, a vehicle control program including a recognition sensor, an information processing device, and a notification device is stored in a storage medium, and the vehicle control program is configured to cause a computer to execute processes including: determining whether a notification condition is satisfied based on information of a recognition result by the recognition sensor, map information of an endemic animal distribution area, and information of an own position of the vehicle, the endemic animal distribution area indicating an area in which a region-specific wild animal inhabits; notifying at least an occupant of a warning or an alert regarding a category of the region-specific wild animal via the notification device when determination is made that the notification condition is satisfied; and executing danger avoidance driving for avoiding a danger caused by the region-specific wild animal based on a predetermined condition when the information of the recognition result includes detection information of the region-specific wild animal.

According to the vehicle control system, the vehicle control method, and the vehicle control program of the present disclosure, it is determined whether the notification condition is satisfied. The determination is based on the information of the recognition result by the recognition sensor, the map information of the endemic animal distribution area, and the information of the own position of the vehicle. The endemic animal distribution area indicates an area in which the region-specific wild animal inhabits. At least an occupant is notified of a warning or an alert regarding a category of the region-specific wild animal via the notification device when determination is made that the notification condition is satisfied. Further, the danger avoidance driving for avoiding a danger caused by the region-specific wild animal based on a predetermined condition is executed when the region-specific wild animal is detected. Thus, it is possible for the vehicle to avoid the danger from the region-specific wild animal when the region-specific wild animal appears. This makes it possible to achieve both the notification of the warning or the alarm regarding the region-specific wild animal to the occupant and ensuring safety of the occupant at the time of appearance of the region-specific wild animal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram illustrating an application example of a vehicle control system according to a first embodiment;

FIG. 2 is an explanatory diagram illustrating an application example of the vehicle control system according to the first embodiment;

FIG. 3 is a block diagram illustrating a configuration example of the vehicle control system according to the first embodiment;

FIG. 4 is a flowchart illustrating a processing example of the information processing device in the vehicle control system according to the first embodiment;

FIG. 5 is an explanatory view illustrating an application example of the vehicle control system according to the first modification example of the first embodiment; and

FIG. 6 is a diagram illustrating a configuration example of the vehicle control system according to a second embodiment.

### DETAILED DESCRIPTION OF EMBODIMENTS

A vehicle control system, a vehicle control method, and a vehicle control program according to an embodiment of the present disclosure will be described with reference to the accompanying drawings. Note that the vehicle control method and the vehicle control program according to the embodiment are realized by computer processing of the vehicle control system according to the embodiment.

### First Embodiment

### 1. Overview

In areas where wild animals peculiar to the region have actually appeared, or in areas where wild animals peculiar to the region are likely to appear, signs or the like for calling attention are installed. In addition, in a case where the vehicle travels in the area, a warning prompting an alert may be output via the notification device. Based on these information, the occupant travels while being alert to the surroundings. However, regional wild animals are not necessarily present in the area. In addition, it is considered that wild animals peculiar to the region appear outside the area. Therefore, if a wild animal peculiar to a region appears regardless of whether or not the wild animal is within the area, it is necessary to notify the occupant of an alarm regarding detection information of the wild animal peculiar to the region. As methods for detecting wildlife peculiar to the region, for example, the detection may be performed using a recognition sensor such as an in-vehicle camera, a Laser Imaging Detection and Ranging (LiDAR) sensor, or a radar.

Here, the psychological condition of the occupant when the wild animal peculiar to the region appears will be considered. When the distance from the vehicle to the wild animal peculiar to the region is a certain distance or more, it is considered that the optimum driving operation can be determined while the occupant hears how the wild animal peculiar to the region behaves. The optimum driving operation is an optimum driving operation for ensuring the safety of the occupant. On the other hand, when the distance from the vehicle to the wild animal specific to the region is not a certain distance or more, and the wild animal specific to the region is a dangerous animal, it is considered that it is difficult for the occupant to instantaneously determine the optimum driving operation. Therefore, in such a case, there is a need for a mechanism that notifies an occupant of an alarm regarding a type of wild animal specific to a region and performs a driving operation to avoid a crisis from the wild animal specific to the region.

Note that the above-described warning or warning may be notified to a surrounding object such as another vehicle or a pedestrian existing in the vicinity of the vehicle other than the occupant. Specifically, the vehicle is provided with a communication device capable of communicating with other vehicles. The vehicle may transmit information related to a warning or an alarm via the communication device, or may include an external notification device such as a display device or a speaker outside the vehicle. The vehicle may output information related to the warning or the warning via the external notification device.

In the vehicle control system according to the present embodiment, it is determined whether or not the notification condition is satisfied based on the information of the recognition result by the recognition sensor, the map information of the endemic animal distribution area, and the information of the self-position of the vehicle. The endemic animal distribution area indicates an area in which the region-specific wild animal inhabits. When the vehicle control system determines that the notification condition is satisfied, at least the occupant is notified of a warning or an alarm regarding the type of wild animal specific to the region. In addition, when the information of the recognition result includes the detection information of the wild animal specific to the region, the danger avoidance driving is executed. The danger avoidance driving is an operation for avoiding a crisis caused by a wild animal specific to a region based on a predetermined condition. As a result, it is possible to achieve both notification of information on wild animals specific to the region to the occupant and assurance of safety of the occupant at the time of appearance of wild animals specific to the region.

Hereinafter, the vehicle control system according to the first embodiment will be described in detail.

### 2. Examples

### 2-1. Application Example of Vehicle Control System

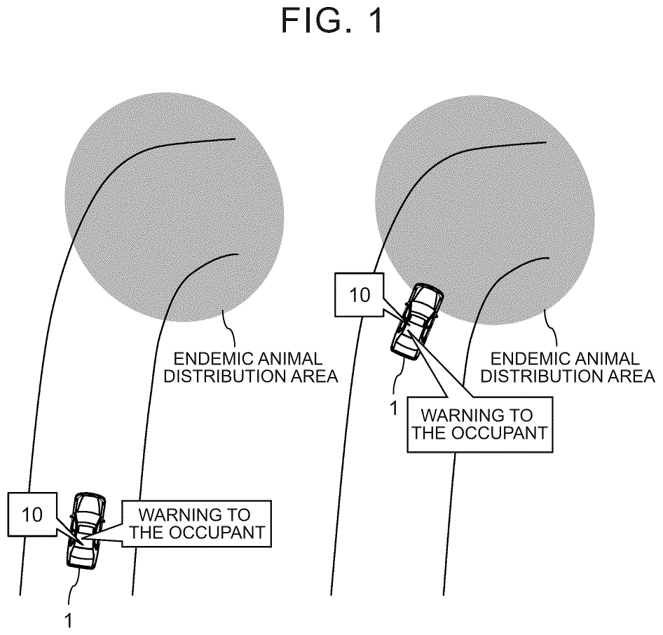

FIG. 1 is a diagram illustrating an application example of a vehicle control system 10 according to a first embodiment. The vehicle control system 10 controls the vehicle 1. Typically, the vehicle control system 10 is mounted on the vehicle 1. The vehicle 1 may be a manually drivable vehicle or an autonomous vehicle. The autonomous driving means that the steering, acceleration, and deceleration of the vehicle 1 are performed automatically independently of the operation of the driver. For example, as the automatic operation, a technology (so-called level 3 or higher automatic operation) is assumed on the assumption that the driver does not necessarily have to concentrate on 100% operation.

Based on the information on the self-position of the vehicle 1 and the map information of the endemic animal distribution area, the vehicle control system 10 calculates the distance from the self-position of the vehicle 1 to the endemic animal distribution area. The endemic animal distribution area indicates an area in which the region-specific wild animal inhabits. When the condition that the distance is less than the threshold value (hereinafter, referred to as “first condition”) is satisfied, the vehicle control system 10 notifies the occupant of a warning regarding the type of wild animal specific to the region, as illustrated in the left diagram of FIG. 1. Examples of the native wild animals include wild boars, bears, deer, and the like.

As shown in the right view of FIG. 1, when the condition that the vehicle 1 has entered the endemic animal distribution area, that is, the condition that the self-position of the vehicle 1 is included in the specific animal distribution area (hereinafter, referred to as “second condition”) is satisfied, the vehicle control system 10 notifies the occupant of a warning regarding the type of wild animal specific to the area. The vehicle control system 10 may perform the notification only once when the vehicle 1 enters the endemic animal distribution area. Alternatively, the vehicle control system 10 may constantly notify the notification while the vehicle 1 is entering the endemic animal distribution area.

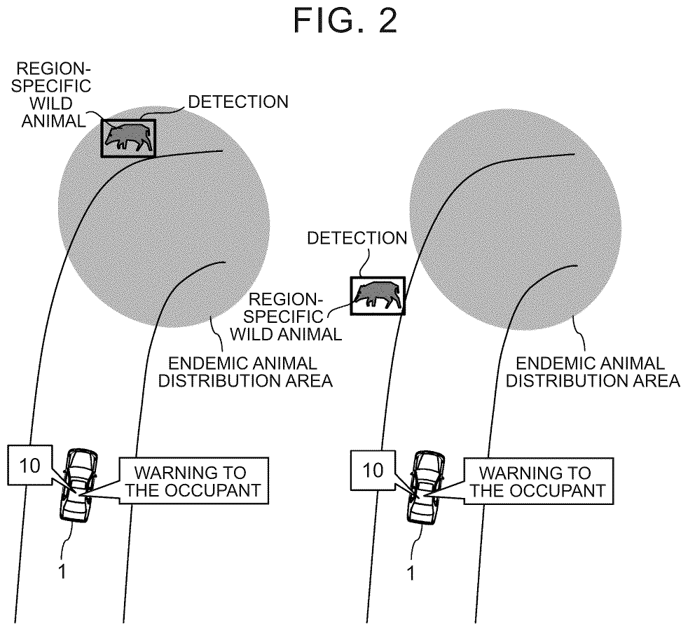

FIG. 2 is a diagram illustrating an application example of the vehicle control system 10 in a case where a wild animal peculiar to a region appears. When the condition that the wild animal specific to the region is detected by the recognition sensor (hereinafter, referred to as “third condition”) is satisfied, the vehicle control system 10 notifies the occupant of an alarm regarding the type of the wild animal specific to the region. In the left view of FIG. 2, an example is shown in which the recognition sensor detects a wild animal specific to a region within an endemic animal distribution area. On the other hand, in the right view of FIG. 2, an example is shown in which the recognition sensor detects a wild animal peculiar to a region outside the endemic animal distribution area. That is, when the recognition sensor detects a wild animal specific to the region regardless of the endemic animal distribution area, the vehicle control system 10 notifies the occupant of an alarm regarding the type of the wild animal specific to the region.

When at least one of the first, second, and third conditions is satisfied while the vehicle 1 is traveling, the vehicle control system 10 determines that the notification condition is satisfied. As described above, when the notification condition including at least one of the first, second, and third conditions is satisfied while the vehicle 1 is traveling, the vehicle control system 10 notifies the occupant of a warning or an alarm regarding the type of wild animal specific to the region. When it is determined that the notification condition is satisfied by at least the third condition being satisfied, the vehicle control system 10 notifies the occupant of an alarm regarding the type of wild animal specific to the region. On the other hand, when it is determined that the notification condition is satisfied without the third condition being satisfied, the vehicle control system 10 notifies the occupant of a warning regarding the type of wild animal specific to the region.

### 2-2. Danger Avoidance Driving

After the warning associated with the occurrence of the wild animal specific to the region is notified, the danger avoidance driving according to the situation is executed. Specifically, the danger avoidance driving is executed based on a predetermined condition.

The predetermined condition includes at least one of a distance from the vehicle 1 to the wild animal specific to the region detected by the recognition sensor being less than a threshold value, and a risk level of the wild animal specific to the region being equal to or higher than a predetermined level.

The danger avoidance driving includes at least one of a vehicle operation, an operation of changing a travel route of the vehicle 1, an operation of locking a door of the vehicle 1, an operation of bringing a window of the vehicle 1 into a fully closed state, and an operation of performing control of suppressing a driving sound of the vehicle 1. The vehicle operation includes at least one operation of steering, acceleration, and deceleration of the vehicle 1.

When the predetermined condition is satisfied, an operation of the danger avoidance driving may be determined according to the contents of the predetermined condition. For example, it is assumed that a wild animal specific to a region is deer. In this case, it is considered that the vehicle 1 is unlikely to be damaged by the deer. Therefore, it is not necessary to perform all the operations described above as the danger avoidance driving, and the vehicle 1 may perform the minimum operation capable of avoiding the deer. Next, it is assumed that the wild animal specific to the region is a wild boar. In this case, it is considered that the vehicle 1 is highly likely to be damaged by the wild boar. Therefore, as the danger avoidance driving, all the operations described above, which are the maximum operations that the vehicle 1 can avoid wild boars, are executed.

### 3. Vehicle Control System

### 3-1. Configuration Example

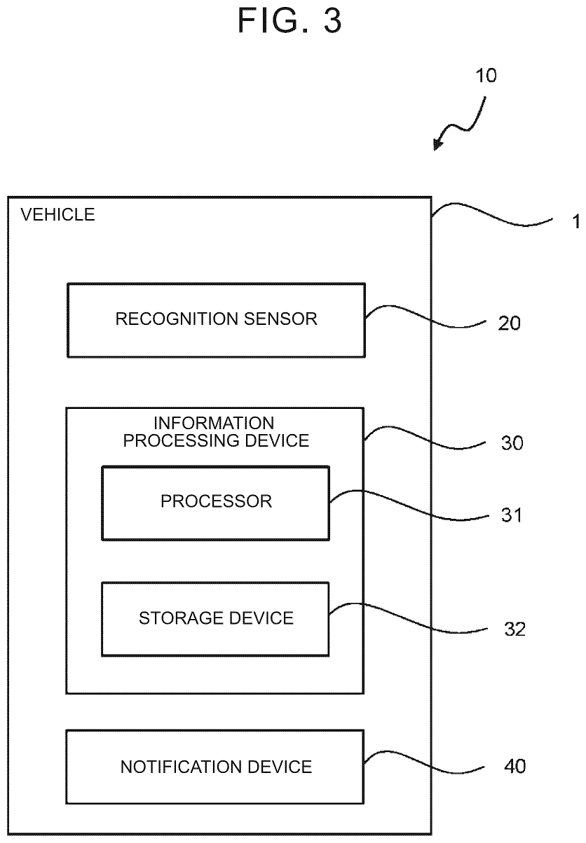

FIG. 3 is a block diagram illustrating a configuration example of the vehicle control system 10 according to the first embodiment. The vehicle control system 10 includes a recognition sensor 20, an information processing device 30, and a notification device 40. The information processing device 30 includes a processor 31 and a storage device 32. Details of each configuration will be described later. However, since the recognition sensor is the same as the above-described content, a description thereof will be omitted.

The information processing device 30 performs various processes. For example, the information processing device 30 may be an Electronic Control Unit (ECU). The information processing device 30 includes one or a plurality of processors 31 (hereinafter, simply referred to as processors 31) and one or a plurality of storage devices 32 (hereinafter, simply referred to as storage devices 32). The processor 31 executes various processes. For example, the processor 31 may be a Central Processing Unit (CPU). The storage device 32 stores data of various types of information. Examples of the storage device 32 include volatile memory, non-volatile memory, Hard Disk Drive (HDD), Solid State Drive (SSD), and the like. Examples of the data of the various kinds of information include data of the information of the recognition result by the recognition sensor 20, data of the map information of the endemic animal distribution area, and data of the information of the self-position of the vehicle 1. The processor 31 executes a vehicle control program that is a computer program to implement the functions of the vehicle control system 10. The vehicle control program is stored in the storage device 32. The vehicle control program may be recorded in a computer-readable storage medium. The vehicle control program may be provided via a network.

The recognition result information stored in the storage device 32 includes detection information of a wild animal specific to a region, information on a distance from the vehicle 1 to the wild animal specific to the region, and information on a degree of danger of the wild animal specific to the region.

The notification device 40 is an output device. The output device notifies at least one of the occupant and the surrounding object of a warning or an alarm regarding the type of wild animal specific to the region. Examples of the notification device 40 include an in-vehicle signage, a display, a speaker, and an information terminal device held by an occupant.

### 3-2. Example of Processing

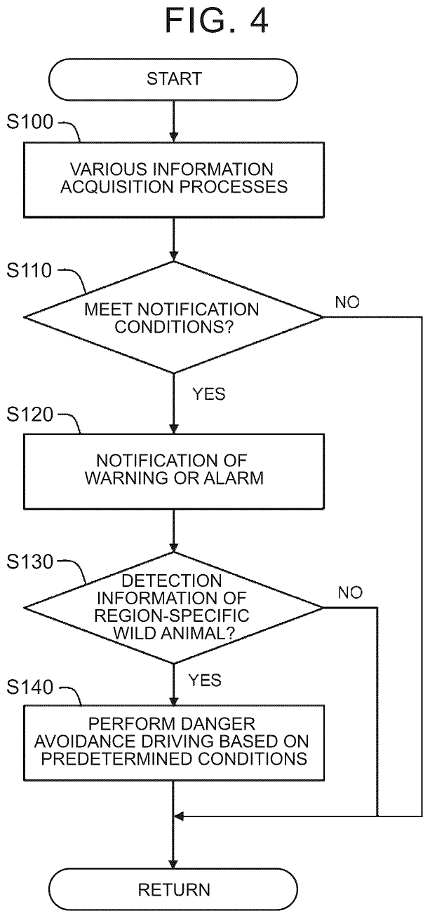

FIG. 4 is a flowchart illustrating a processing example of the information processing device 30. The routine illustrated in FIG. 4 is repeatedly executed at a predetermined cycle.

In S100 of steps, the information processing device 30 acquires various types of information stored in the storage device 32. Thereafter, the process proceeds to step S110. The various types of information include information on a recognition result.

In the step S110, the information processing device 30 determines whether or not the notification condition is satisfied based on the various types of information. If it is determined that the notification condition is satisfied (step S110; Yes), the process proceeds to step S120. Otherwise (S110; No of steps), the process ends.

In S120 of steps, the information processing device 30 notifies at least one of the occupant and the surrounding object of a warning or warning regarding the type of wildlife specific to the region via the notification device 40. Thereafter, the process proceeds to step S130.

In S130 of steps, the information processing device 30 determines whether or not the recognition-result information includes the detection information of the wild-animal specific to the region. When it is determined that the recognition-result information includes the detection information of the wild-animal specific to the region (step S130; Yes), the process proceeds to step S140. Otherwise (S130; No of steps), the process ends.

In the step S140, the information processing device 30 executes the danger avoidance driving based on the predetermined condition.

### 4. First Modification

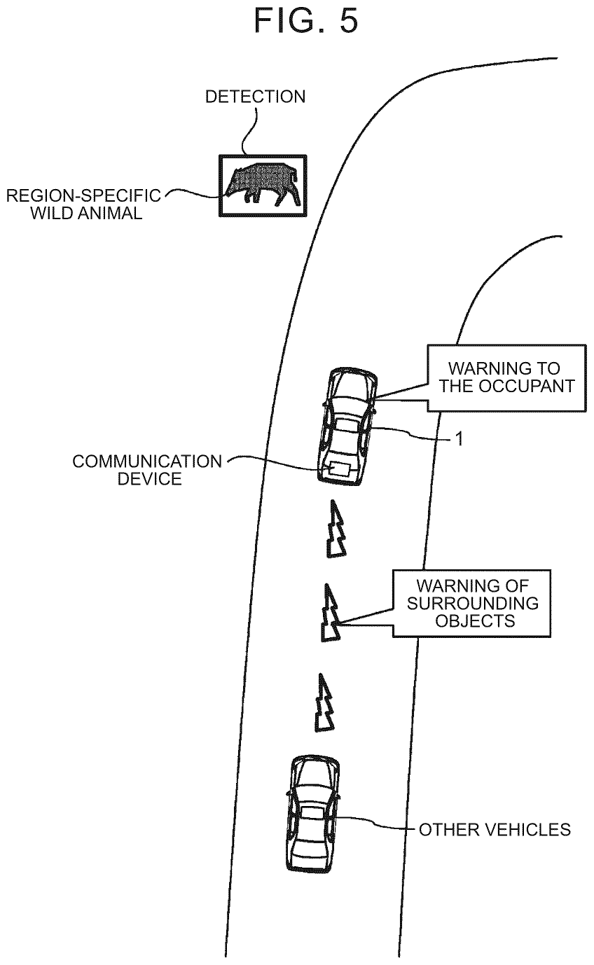

FIG. 5 is an explanatory diagram illustrating an application example of the vehicle control system 10 according to the first modification example of the first embodiment. Specifically, an example in which notification is given to a surrounding object of the vehicle 1 is illustrated. The vehicle control system 10 according to the above-described first embodiment notifies a surrounding object of a warning or an alert via the notification device mounted on the vehicle. On the other hand, as illustrated in FIG. 5, the vehicle control system 10 according to the first modification includes a communication device capable of communicating with another vehicle. The vehicle control system 10 may transmit warning or warning notification data to a notification device included in another vehicle via the communication device. As a result, when a wild animal peculiar to the region appears, the vehicle control system 10 can immediately notify the surrounding object located at a position away from the vehicle 1 of information such as the type of the wild animal peculiar to the region, the detection position, and the like.

### Second Modification

In the vehicle control system 10 according to the first embodiment, when a wild animal specific to a region is detected, danger avoidance driving is executed. On the other hand, in the vehicle control system 10 according to the second modification of the first embodiment, when a wild animal specific to the region is detected, the danger avoidance driving may be executed, and the data of the map information of the endemic animal distribution area may be updated based on the detection information of the wild animal specific to the region. Accordingly, based on the map information of the latest endemic animal distribution area, a warning regarding the type of the wild animal specific to the region is notified to at least one of the occupant and the surrounding object.

### Second Embodiment

The vehicle control system 10 according to the second embodiment is a control system including the vehicle 1 and a management device 60 capable of communicating with the vehicle 1. In the vehicle control system 10 according to the first embodiment described above, the data of the map information of the endemic animal distribution area is managed by the vehicle 1. On the other hand, the vehicle control system according to the second embodiment manages the data of the map information of the endemic animal distribution area by the management device 60. As a result, the information regarding the specific-region wild animals detected by the vehicle 1 and the other vehicle is reflected in the map information of the endemic animal distribution area. Therefore, the accuracy of the map information of the endemic animal distribution area is improved. Based on the map information of the latest endemic animal distribution area, a warning regarding the type of wild animal specific to the region is notified to at least one of the occupant or the surrounding object. Therefore, it is possible for the occupant to perform the danger avoidance action before the danger avoidance driving associated with the appearance of the wild animal peculiar to the region is executed.

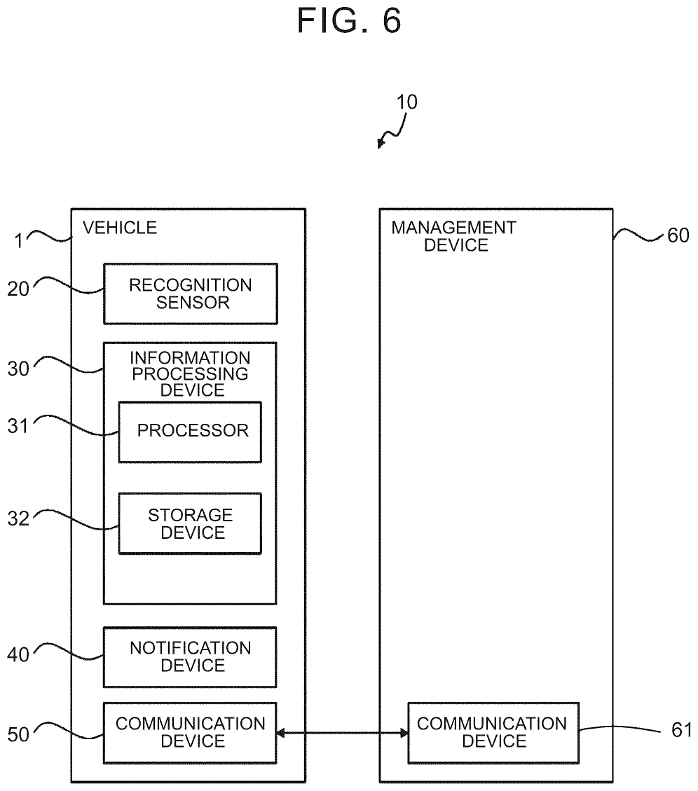

FIG. 6 is a block diagram illustrating a configuration example of the vehicle control system 10 according to the second embodiment. Here, a difference from the vehicle control system 10 according to the first embodiment will be described. The vehicle control system 10 according to the second embodiment includes a vehicle 1 and a management device 60. The vehicle 1 includes a recognition sensor 20, an information processing device 30, a notification device 40, and a communication device 50. The management device 60 includes a communication device 61. The communication device 50 receives data of the map information of the endemic animal distribution area from the management device 60. When a wild animal specific to a region appears, the communication device 50 transmits detection information of the wild animal specific to the region to the management device 60. The management device 60 updates the data of the map information of the endemic animal distribution area based on the detection information of the wild animal specific to the region.

What is claimed is:

1. A vehicle control system comprising:
a recognition sensor;
a notification device; and
an information processing device that executes processes including
determining whether a notification condition is satisfied based on information of a recognition result by the recognition sensor, map information of an endemic animal distribution area, and information of an own position of a vehicle, the endemic animal distribution area indicating an area in which a region-specific wild animal inhabits,
notifying at least an occupant of a warning or an alert regarding a category of the region-specific wild animal via the notification device when the information processing device determines that the notification condition is satisfied, and
executing danger avoidance driving for avoiding a danger caused by the region-specific wild animal based on a predetermined condition when the information of the recognition result includes detection information of the region-specific wild animal.

2. The vehicle control system according to claim 1, wherein the information processing device is configured to acquire the map information of the endemic animal distribution area from a management device that is able to communicate with the vehicle.

3. The vehicle control system according to claim 1, wherein:
the notification condition includes at least one of conditions including
a first condition in which a distance from the own position to the endemic animal distribution area is less than a threshold value,
a second condition in which the own position is included in the endemic animal distribution area, and
a third condition in which the information of the recognition result includes the detection information of the region-specific wild animal; and
the information processing device is configured to determine that the notification condition is satisfied when at least one of the first condition, the second condition, and the third condition is satisfied.

4. The vehicle control system according to claim 3, wherein the information processing device is configured to execute processes including:
notifying at least the occupant of the alert regarding the category of the region-specific wild animal via the notification device when determination is made that the notification condition is satisfied by at least satisfying the third condition; and
notifying at least the occupant of the warning regarding the category of the region-specific wild animal via the notification device when determination is made that the notification condition is satisfied without satisfying the third condition.

5. The vehicle control system according to claim 1, wherein:
the information of the recognition result includes information of a distance from the vehicle to the region-specific wild animal and information of a danger level of the region-specific wild animal; and
the predetermined condition includes at least one of a condition in which the distance is less than a threshold value and a condition in which the danger level is equal to or higher than a predetermined level.

6. The vehicle control system according to claim 1, wherein the danger avoidance driving includes at least one of operations including:
at least one vehicle operation from among steering, acceleration, and deceleration of the vehicle;
an operation for changing a travel route of the vehicle;
an operation for locking a door of the vehicle;
an operation for fully closing a window of the vehicle; and
an operation for controlling suppression of a driving sound of the vehicle.

7. A vehicle control method including a recognition sensor, an information processing device, and a notification device, the vehicle control method comprising:
determining whether a notification condition is satisfied based on information of a recognition result by the recognition sensor, map information of an endemic animal distribution area, and information of an own position of the vehicle, the endemic animal distribution area indicating an area in which a region-specific wild animal inhabits;
notifying at least an occupant of a warning or an alert regarding a category of the region-specific wild animal via the notification device when determination is made that the notification condition is satisfied; and
executing danger avoidance driving for avoiding a danger caused by the region-specific wild animal based on a predetermined condition when the information of the recognition result includes detection information of the region-specific wild animal.

8. A non-transitory storage medium storing a vehicle control program including a recognition sensor, an information processing device, and a notification device, the vehicle control program being configured to cause a computer to execute processes comprising:
determining whether a notification condition is satisfied based on information of a recognition result by the recognition sensor, map information of an endemic animal distribution area, and information of an own position of the vehicle, the endemic animal distribution area indicating an area in which a region-specific wild animal inhabits;
notifying at least an occupant of a warning or an alert regarding a category of the region-specific wild animal via the notification device when determination is made that the notification condition is satisfied; and
executing danger avoidance driving for avoiding a danger caused by the region-specific wild animal based on a predetermined condition when the information of the recognition result includes detection information of the region-specific wild animal.
